(19) United States
(12) Patent Application Publication
(10) Pub. No.: US 2008/0000160 A1
(43) Pub. Date: Jan. 3, 2008

(54) Moving motor pull type window regulator

(75) Inventors: Everardo A. Hernandez, Shelby Township, MI (US); Santhosh Kumar Karumuri, Inkster, MI (US)

Correspondence Address: CARLSON, GASKEY & OLDS, P.C., 400 WEST MAPLE ROAD, SUITE 350, BIRMINGHAM, MI, 48009, US

(73) Assignee: ArvinMeritor Technology, LLC

(21) Appl. No.: 11/478,035

(22) Filed: Jun. 29, 2006

(51) Int. Cl. E05F 11/48

(52) U.S. Cl. 49/352

(57) ABSTRACT

A window regulator includes a cursor mounted for movement along a window track, a motor mounted to the cursor to move a vehicle window between open and closed positions, and a cable in driving engagement with a motor output. The cursor comprises a single piece component that includes a window mount portion and a motor mount portion with the motor being rigidly fixed to the motor mount portion for movement with the cursor. The motor output cooperates with the cable to move the motor, the cursor and the vehicle window together as a unit along the window track.

### TECHNICAL FIELD

The subject invention relates generally to a window regulator for moving a vehicle window between open and closed positions.

### BACKGROUND OF THE INVENTION

Window regulators are used to move windows in a vehicle between open and closed positions. There are many different types of window regulators. A window regulator is typically mounted to a door module. A guide member, such as a guide rail for example, is separately mounted to the door module to define a guide path for the window as the window regulator drives the window between open and closed positions.

One known type of window regulator uses a rack and pinion configuration for driving the window. Examples of a rack and pinion type window regulator are shown in WO 2005/098186 and WO 2006/028827. Another type of window regulator, such as that disclosed in U.S. Pat. No. 6,928,208, utilizes a lead screw configuration that cooperates with a drive motor and transmission assembly to move the window.

These types of window regulators are complex and require significant number of components, which increases cost and assembly time. Thus, there is a need for a simplified window regulator assembly that requires fewer components, and which is more cost effective.

### SUMMARY OF THE INVENTION

A window regulator is mounted to a door module. The window regulator includes a cursor or lift plate mounted for movement along a window track, a motor mounted to the cursor to move a window between open and closed positions, and a cable in driving engagement with a motor output to move the motor, the cursor and the window together as a unit along the window track.

In one example, the cursor comprises a single piece component that includes a window mount portion, a window track mount portion, and a motor mount portion. The window mount portion holds the window, and the motor is rigidly fixed to the motor mount portion for movement with the cursor. The window track mount portion comprises a pair of guide grooves that receive outward edges of the window track such that the cursor can slide or move along a path defined by the window track.

In one example, the window track and the door module are integrally formed together as a single piece component. The window track and door module could be formed from a plastic material or a steel material, for example.

In one example, the cable comprises a toothed element. A gear drive is driven by the motor output. The gear drive engages the toothed element to drive the gear drive, motor, cursor, and window as a unit along the window track.

In one example, the window mount portion of the cursor comprises a snap type window connection that includes first and second gripping members separated by a slot. An edge of the window is positioned in the slot. One of the first and second gripping members includes a transversely extending snap tang that cooperates with a mounting hole formed in the vehicle window to secure the vehicle window to the cursor.

The subject invention provides a simplified window regulator that significantly reduces the number of components compared to prior window regulators, and which is more cost effective. These and other features of the present invention can be best understood from the following specification and drawings, the following of which is a brief description.

### BRIEF DESCRIPTION OF THE DRAWINGS

FIG. 1 shows a side view of a door module, window, and window regulator incorporating the subject invention.

FIG. 2 is a top view of the door module looking down on the window regulator of FIG. 1.

FIG. 3 is a perspective view of the window regulator of FIG. 1.

FIG. 4 is a perspective view of a window mount portion of the window regulator of FIG. 1.

### DETAILED DESCRIPTION OF THE PREFERRED EMBODIMENT

A window regulator is shown generally at 10 in FIG. 1. The window regulator 10 is mounted to a door module 12 and is used to move a window 14 between open and closed positions. The window regulator includes a motor 16 that is rigidly mounted to a lift plate or cursor 18. The motor 16 cooperates with a toothed element, such as a cable 20, which is mounted to the door module 12 with brackets 22.

At least one window guide or window track 24 is integrally formed with the door module 12. The cursor 18 is mounted for movement with the motor 16 along the window track 24 via a driving interface between the motor 16 and the cable 20. In one example, the door module 12 and the window track 24 are integrally formed or molded as a single piece component from a plastic material. In another example, the door module 12 and the window track 24 are integrally formed as a single piece from a steel material, where the window track 24 comprises a roll formed section in the door module 12. Other materials could also be used to form the window track 24 and door module 12.

The cursor 18 comprises a single piece component and can be made from any type of material such as plastic or steel, for example. The cursor 18 includes a motor mount portion 30, a window track mount portion 32, and a window mount portion 34. The window mount portion 34 preferably comprises a snap type connection, which will be discussed in further detail below.

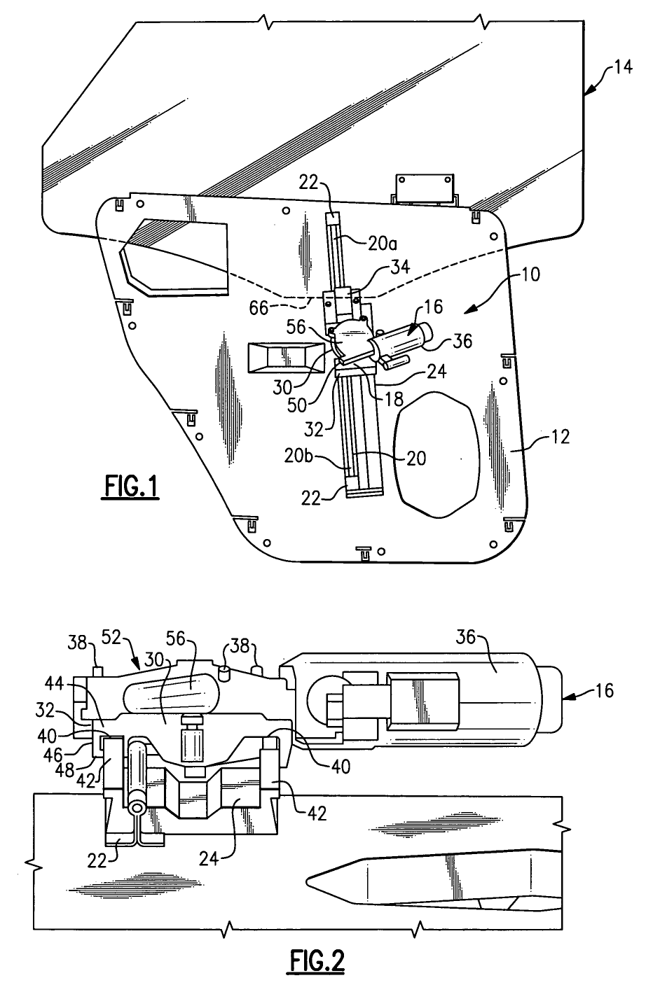

The motor mount portion 30 is formed in the cursor 18 below the window mount portion 34. The motor 16 includes a motor housing 36 that is mounted directly to the motor mount portion 30. The motor mount portion 30 provides an enlarged area that provides a mounting boss for the motor housing 36. Fasteners 38 (FIG. 2), or other types of connectors, are used to fix the motor 16 to the cursor 18. The motor 16 moves with the cursor 18 as a unit, however, the motor housing 36 does not move relative to the cursor itself. This provides a rigid connection for the motor 16 and cursor 18 such that they form a unit that can easily and efficiently move up and down the window track 24.

The window track mount portion 32 is shown most clearly in FIG. 2. In the example shown, the window track mount portion 32 has a rail guide profile formed within the door module 12 that includes a pair of guide grooves 40 that cooperate with outboard edges 42 of the window track 24. The outboard edges 42 of the window track 24 slide within the guide grooves 40 to define a guide path for the window regulator 10 to move the window 14 between open and closed positions.

Each guide groove 40 is defined by an outer flange portion 44 of the bracket 18, a first wall portion 46 that extends transversely to the flange portion 44, and a second wall portion 48 that extends transversely to the first wall portion 46. The second wall portion 48 extends from the first wall portion 46 in a direction that is generally inward toward a center of the cursor 18.

The window track 24 extends generally in a vertical direction. The cable 20 is mounted to extend in the vertical direction along with the window track 24. In the example shown, the cable 20 is positioned laterally between the guide grooves 40. Further, in the example shown, the cable 20 is positioned closer to one guide groove than the other guide groove. As shown in FIG. 1, the cable 20 has an upper end 20a that is mounted at a position vertically above an upper end of the window track 24 with one bracket 22, and a lower end 20b that is mounted at a position vertically below a lower end of the window track 24 with another bracket 22. This configuration provides a compact assembly that does not take undue space in the door module.

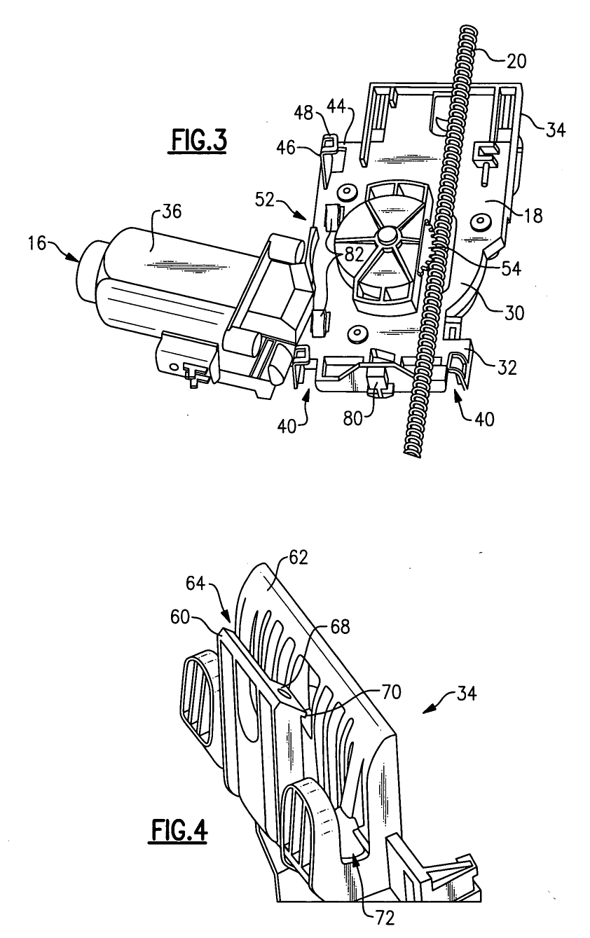

The motor 16 includes a driving output shaft, shown in FIG. 1 as enclosed by motor housing portion 50. This driving output shaft drives a gear drive 52, which is shown in FIG. 3. The gear drive 52 includes at least one gear 54 that is in direct driving engagement with the cable 20. The gear 54 can be driven directly by the output shaft or additional gears can be used to drivingly connect gear 54 to the motor 16, as needed. The gear drive 52 is substantially enclosed by housing portion 56, which is best shown in FIGS. 1 and 2.

As shown in FIG. 3, the motor mount portion 30, the window track mount portion 32, and the window mount portion 34 are all integrally formed as part of cursor 18. Thus, a single piece component, i.e. cursor 18, is used to provide the mounting structure for the motor 16, the window 14, and the window track 24. This configuration has significantly fewer components as compared to prior window regulator configurations.

The window mount portion 34 is shown in greater detail in FIG. 4. As mentioned above, the window mount portion 34 comprises a snap type window connection, and includes first 60 and second 62 gripping members that are separated by a slot 64. A bottom edge 66 (FIG. 1) of the window 14 is received within this slot 64. One of the first 60 and second 62 gripping members includes a transversely extending snap tang 68 that cooperates with an opening (not shown) in the window 14 to secure the window 14 to the bracket 18.

The snap tang 68 is a resilient member that is pushed outwardly as the bottom edge 66 of the window is being inserted into the slot 64. Once the snap tang 68 is aligned with the opening in the window 14, the snap tang 68 is biased to return or “snap” back to the original position, such that a distal end portion 70 of the snap tang 68 grips, grabs or otherwise engages at least a portion of the window 14. The window mount portion 34 thus provides a secure and rigid mount for the window 14.

Optionally, dampers 72 (only one is shown in FIG. 4) are installed within the slot 64. The dampers 72 abut against the bottom edge 66 of the window 14 to reduce noise.

Also, the cursor 18 includes a down stop bumper 80, as shown in FIG. 3. The down stop bumper 80 is mounted directly to a lower portion of the cursor 18.

Further, the cursor 18 includes anti-rattle features 82. The anti-rattle features 82 are used to prevent any noise, vibration and/or harshness issues that could arise due to the presence of the motor 16 on the cursor 18. The anti-rattle features 82 can be formed as part of the cursor 18, or can be separately attached.

The window regulator 10 of the present invention provides a compact, easily installed, and efficient operating assembly. The window regulator 10 utilizes fewer components and thus, is much more cost effective than prior designs.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A window regulator assembly comprising:
a motor including a motor housing and a driving output for moving a window between open and closed positions;
a cursor mounted for movement along a window track, said cursor including a window mount portion adapted to receive the window and a motor mount portion wherein said motor housing is fixed to said motor mount portion for movement with said cursor; and
a cable in driving engagement with said driving output to move said motor, said cursor and the window together as a unit along the window track.

2. The window regulator assembly according to claim 1 wherein said cursor includes a window track mount portion cooperating with the window track to move said cursor along the window track.

3. The window regulator assembly according to claim 2 wherein said window track mount portion comprises first and second vertically extending guide grooves, and wherein said cable extends in a vertical direction and is laterally positioned between said first and said second vertically extending guide grooves.

4. The window regulator assembly according to claim 2 wherein said window mount portion, said motor mount portion, and said window track mount portion are integrally formed with said cursor such that said cursor comprises a single piece component.

5. The window regulator assembly according to claim 1 including a gear drive driven by said driving output of said motor, said gear drive in driving engagement with a toothed portion of said cable.

6. The window regulator assembly according to claim 1 wherein said window mount portion comprises a snap type window connection comprising first and second gripping members separated by a slot for receiving an edge of the window wherein one of said first and said second gripping members includes a transversely extending snap tang that cooperates with the window to secure the window to said cursor.

7. A window regulator assembly comprising:
a window track formed within a door module;
a motor including a motor housing and a driving output for moving a window along said window track between open and closed positions;
a cursor including a window track mount portion cooperating with said window track to move said cursor along said window track, a window mount portion adapted to receive the window, and a motor mount portion wherein said motor housing is fixed to said motor mount portion for movement with said cursor; and
a cable in driving engagement with said driving output to move said motor, said cursor and the window together as a unit along said window track.

8. The window regulator assembly according to claim 7 wherein said window track is integrally formed as a single piece with said door module.

9. The window regulator assembly according to claim 8 wherein said door module is formed from a plastic material such that said door module and said window track form a single piece plastic component.

10. The window regulator assembly according to claim 8 wherein said door module is formed from a steel material with said window track comprising a roll formed steel section.

11. The window regulator assembly according to claim 7 wherein said cursor comprises a single piece component.

12. The window regulator assembly according to claim 7 wherein said motor housing is rigidly mounted to said motor mount portion such that said motor housing does not move relative to said cursor.

13. The window regulator assembly according to claim 7 wherein said cable comprises a toothed element mounted to said door module to extend in the same direction as said window track.

14. The window regulator assembly according to claim 13 wherein said window track mount portion comprises first and second guide grooves that slidably receive outward edges of said window track.

15. The window regulator assembly of claim 14 wherein said cable is positioned laterally between said first guide groove and said second guide groove.

16. The window regulator assembly according to claim 7 wherein said window mount portion comprises a snap type window connection comprising first and second gripping members separated by a slot for receiving an edge of the window wherein one of said first and said second gripping members includes a transversely extending snap tang that cooperates with the window to secure the window to said cursor.
